(19) United States
(12) Patent Application Publication
(10) Pub. No.: US 2015/0066580 A1
(43) Pub. Date: Mar. 5, 2015

(54) CUSTOMER RELATIONSHIP MANAGEMENT SYSTEM AND METHOD

(71) Applicant: International Business Machines Corporation, Armonk, NY (US)

(72) Inventors: Erik S. Bryant, Wake Forest, NC (US); Stephen W. Cole, Cambridge, MA (US); Patrick J. O'Sullivan, Ballsbridge (IE); Stephen Ryan, Mulhuddart (IE); Jolene R. Staruch, Kennebunk, ME (US)

(73) Assignee: International Business Machines Corporation, Armonk, NY (US)

(21) Appl. No.: 14/013,371

(22) Filed: Aug. 29, 2013

(51) Int. Cl. G06Q 30/02; H04L 12/58

(52) U.S. Cl. CPC G06Q 30/0201; H04L 51/046
USPC 705/7.29

(57) ABSTRACT

A method, computer program product, and computer system for sharing, via a first computing device, customer relationship management opportunity data between a customer relationship management application and an instant messaging application, wherein the customer relationship management opportunity data is associated with an opportunity. At least a portion of the customer relationship management opportunity data is provided to an instant messaging application client executed by a second computing device, the instant messaging application client associated with the instant messaging application, wherein at least the portion of the customer relationship management opportunity data is provided for user access at the second computing device via the instant messaging application client.

### BACKGROUND

Customer Relationship Management (CRM) may include, for example, sales, marketing and service/support based functions to move a customer through a sales pipeline with an example goal of keeping the customer coming back to buy more and more products. CRM may be generally based around data and information that company brands may collect on their customers, all of which may go into a CRM system that may then allow the company to better target various customers.

Social CRM may generally be described as a strategy that may be supported by various tools and technologies. The strategy may be broadly based around customer engagement and interactions, with transactions being a byproduct. Social CRM may represent an evolved form of CRM, in which a back-end process and system for managing customer relationships and data may be provided in an efficient and process-centric way. Social CRM may be one component of developing a social or collaborative business, both internally and externally.

There are some differences between CRM and Social CRM. For example, CRM may often consist of one-way communication between a business and the customer. Social CRM may be an evolution of the CRM paradigm, and may represent the use of social media services, techniques and technology to enable organizations to engage with their customers. Social CRM may have example applications in, e.g., marketing, customer service and sales, including peer-to-peer customer support, idea management, market research, product launch, brand reputation management.

### BRIEF SUMMARY OF DISCLOSURE

In one implementation, a method, performed by one or more computing devices, may comprise sharing, via a first computing device, customer relationship management opportunity data between a customer relationship management application and an instant messaging application, wherein the customer relationship management opportunity data is associated with an opportunity. At least a portion of the customer relationship management opportunity data is provided to an instant messaging application client executed by a second computing device, the instant messaging application client associated with the instant messaging application, wherein at least the portion of the customer relationship management opportunity data is provided for user access at the second computing device via the instant messaging application client.

One or more of the following features may be included. At least the portion of the customer relationship management opportunity data may include one or more contacts associated with the opportunity. At least the portion of the customer relationship management opportunity data may include at least one status associated with the opportunity. At least one status associated with the opportunity may include at least one sale stage associated with the opportunity. Providing at least the portion of the customer relationship management opportunity data may include providing one or more updates associated with the customer relationship management opportunity data. The one or more updates may be provided dynamically. An indication may be received from the second computing device that the opportunity is added to the instant messaging application client, wherein at least the portion of the customer relationship management opportunity data may be provided in response to receiving the indication.

In another implementation, a computing system includes a processor and a memory configured to perform operations that may comprise sharing, via a first computing device, customer relationship management opportunity data between a customer relationship management application and an instant messaging application, wherein the customer relationship management opportunity data is associated with an opportunity. At least a portion of the customer relationship management opportunity data is provided to an instant messaging application client executed by a second computing device, the instant messaging application client associated with the instant messaging application, wherein at least the portion of the customer relationship management opportunity data is provided for user access at the second computing device via the instant messaging application client.

One or more of the following features may be included. At least the portion of the customer relationship management opportunity data may include one or more contacts associated with the opportunity. At least the portion of the customer relationship management opportunity data may include at least one status associated with the opportunity. At least one status associated with the opportunity may include at least one sale stage associated with the opportunity. Providing at least the portion of the customer relationship management opportunity data may include providing one or more updates associated with the customer relationship management opportunity data. The one or more updates may be provided dynamically. An indication may be received from the second computing device that the opportunity is added to the instant messaging application client, wherein at least the portion of the customer relationship management opportunity data may be provided in response to receiving the indication.

In another implementation, a computer program product resides on a computer readable storage medium that has a plurality of instructions stored on it. When executed by a processor, the instructions cause the processor to perform operations that may comprise sharing, via a first computing device, customer relationship management opportunity data between a customer relationship management application and an instant messaging application, wherein the customer relationship management opportunity data is associated with an opportunity. At least a portion of the customer relationship management opportunity data is provided to an instant messaging application client executed by a second computing device, the instant messaging application client associated with the instant messaging application, wherein at least the portion of the customer relationship management opportunity data is provided for user access at the second computing device via the instant messaging application client.

One or more of the following features may be included. At least the portion of the customer relationship management opportunity data may include one or more contacts associated with the opportunity. At least the portion of the customer relationship management opportunity data may include at least one status associated with the opportunity. At least one status associated with the opportunity may include at least one sale stage associated with the opportunity. Providing at least the portion of the customer relationship management opportunity data may include providing one or more updates associated with the customer relationship management opportunity data. The one or more updates may be provided dynamically. An indication may be received from the second computing device that the opportunity is added to the instant messaging application client, wherein at least the portion of the customer relationship management opportunity data may be provided in response to receiving the indication.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of an opportunity management process coupled to a distributed computing network according to one or more implementations of the present disclosure;

FIG. 2 is a diagrammatic view of a client electronic device of FIG. 1 according to one or more implementations of the present disclosure;

FIG. 3 is an illustrative flowchart of the opportunity management process of FIG. 1 according to one or more implementations of the present disclosure;

FIG. 4 is an illustrative diagrammatic view of a screen image displayed by the opportunity management process of FIG. 1 according to one or more implementations of the present disclosure; and

FIG. 5 is an illustrative diagrammatic view of a screen image displayed by the opportunity management process of FIG. 1 according to one or more implementations of the present disclosure.

Like reference symbols in the various drawings indicate like elements.

### DETAILED DESCRIPTION

### System Overview

As will be appreciated by one skilled in the art, the present disclosure may be embodied as a method, system, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

Computer program code for carrying out operations of the present disclosure may be written in an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript or PERL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider).

The flowchart and block diagrams in the figures illustrate the architecture, functionality, and operation of possible implementations of apparatus (systems), methods and computer program products according to various implementations of the present disclosure. It will be understood that each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

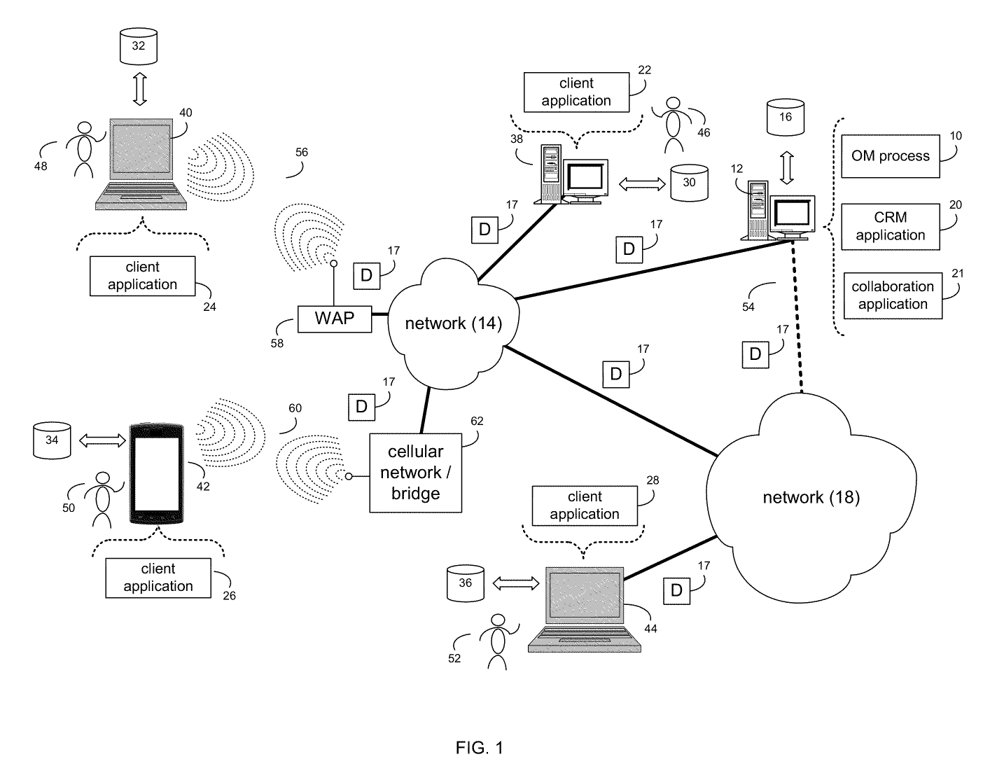

Referring to FIG. 1, there is shown opportunity management (OM) process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, OM process 10 may share, via a first computing device, customer relationship management opportunity data (e.g., data 17) between a customer relationship management application and an instant messaging application, wherein the customer relationship management opportunity data may be associated with an opportunity. At least a portion of the customer relationship management opportunity data may be provided to an instant messaging application client executed by a second computing device, the instant messaging application client associated with the instant messaging application, wherein at least the portion of the customer relationship management opportunity data may be provided for user access at the second computing device via the instant messaging application client.

The instruction sets and subroutines of OM process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data described throughout the present disclosure may be stored in the data store. In some implementations, computer 12 may utilize a database management system such as, but not limited to, “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. OM process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a customer relationship management application (e.g., CRM application 20), examples of which may include, but are not limited to, e.g., a sales based application, a marketing based application, a service/support based application, or other application that allows for the management of customer relationships. Examples of a CRM application may include, for example, Sugar or Siebel, or the like. (Sugar is a trademark of SugarCRM Inc. in the United States, other countries, or both; Siebel is a trademark of Oracle Corporation in the United States, other countries, or both.) CRM application 20 may also include aspects of social customer relationship management (SCRM), which may include, but is not limited to marketing applications, customer service and sales applications (including peer-to-peer customer support), idea management applications, market research applications, product launch applications, and brand reputation management applications. Computer 12 may also execute a collaboration application (e.g., collaboration application 21), examples of which may include, but are not limited to, e.g., an instant messaging (IM) application, a web conferencing application, a video conferencing application, a voice-over-IP application, a video-over-IP application, presence system application, or other application that allows for virtual meeting and/or remote collaboration, and/or that allows users to subscribe to each other and be notified of changes in state.

OM process 10 and/or CRM application 20 and/or collaboration application 21 may be accessed via client applications 22, 24, 26, 28. OM process 10 may be a stand alone application, or may be an applet/application/script that may interact with and/or be executed within CRM application 20, and/or collaboration application 21, and/or one or more of client applications 22, 24, 26, 28. CRM application 20 and/or collaboration application 21 may be a stand alone application, or may be an applet/application/script that may interact with and/or be executed within OM process 10 and/or one or more of client applications 22, 24, 26, 28. One or more of client applications 22, 24, 26, 28 may be a stand alone application, or may be an applet/application/script that may interact with and/or be executed within OM process 10 and/or CRM application 20 and/or collaboration application 21. Examples of client applications 22, 24, 26, 28 may include, but are not limited to, e.g., a sales based application, a marketing based application, a service/support based application, or other application that allows for the management of customer relationships, a social media application, an instant messaging (IM) client application, a standard and/or mobile web browser, an email client application, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36 coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of OM process 10 (and vice versa). Accordingly, OM process 10 may be a purely server-side application, a purely client-side application, or a hybrid server-side/client-side application that is cooperatively executed by one or more of client applications 22, 24, 26, 28 and/or OM process 10.

One or more of client applications 22, 24, 26, 28 may be configured to effectuate some or all of the functionality of CRM application 20 and/or collaboration application 21 (and vice versa). Accordingly, CRM application 20 and/or collaboration application 21 may be a purely server-side application, a purely client-side application, or a hybrid server-side/client-side application that is cooperatively executed by one or more of client applications 22, 24, 26, 28 and/or CRM application 20 and/or collaboration application 21. As one or more of client applications 22, 24, 26, 28, OM process 10, CRM application 20, and collaboration application 21, taken singly or in any combination, may effectuate some or all of the same functionality, any description of effectuating such functionality via one or more of client applications 22, 24, 26, 28, OM process 10, CRM application 20, collaboration application 21, or combination thereof, and any described interaction(s) between one or more of client applications 22, 24, 26, 28, OM process 10, CRM application 20, collaboration application 21, or combination thereof to effectuate such functionality, should be taken as an example only and not to limit the scope of the disclosure.

Users 46, 48, 50, 52 may access computer 12 and OM process 10 (e.g., using one or more of client electronic devices 38, 40, 42, 44) directly through network 14 or through secondary network 18. Further, computer 12 may be connected to network 14 through secondary network 18, as illustrated with phantom link line 54. OM process 10 may include one or more user interfaces, such as browsers and textual or graphical user interfaces, through which users 46, 48, 50, 52 may access OM process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

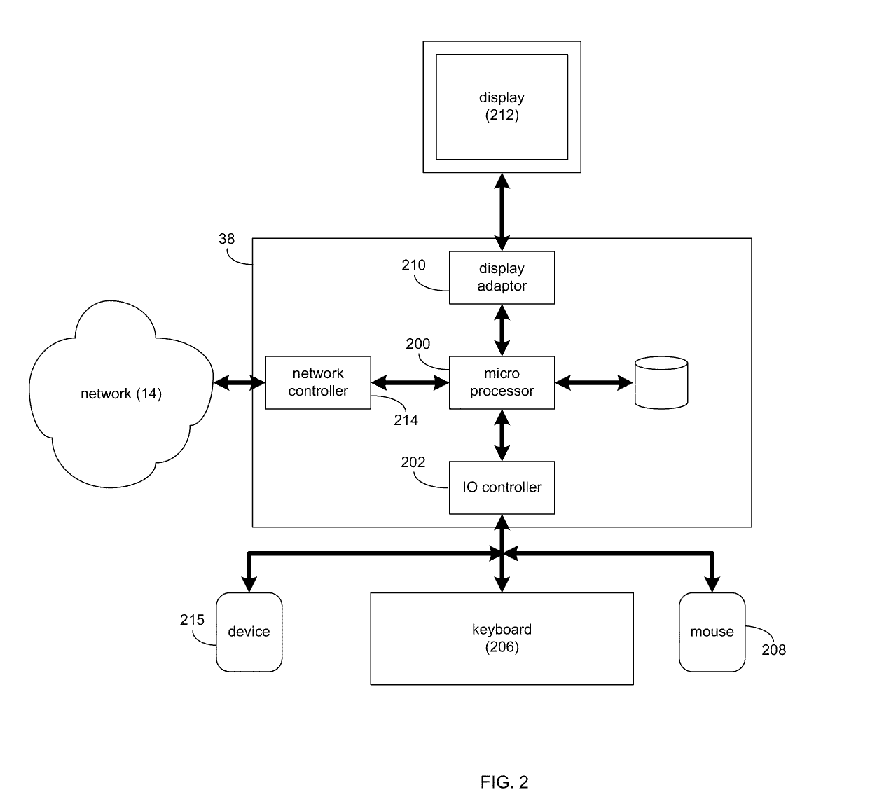

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, OM process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device. An I/O controller (e.g., I/O controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

CRM may include, for example, sales, marketing and service/support based functions to move a customer through a sales pipeline with the goal of keeping the customer coming back to buy more and more products. CRM may be generally based around data and information that company brands may collect on their customers, all of which would go into a CRM system (e.g., CRM application 20) that then allowed the company to better target various customers.

Social CRM may generally be described as a strategy that may be supported by various tools and technologies. The strategy may be broadly based around customer engagement and interactions, with transactions being a byproduct. Social CRM may represent an evolved form of CRM, in which a back-end process and system for managing customer relationships and data may be provided in an efficient and process-centric way. Social CRM may mean different things to different organizations, with a common aspect of being able to understand the business challenge one is looking to solve, and then solving it. Social CRM may be one component of developing a social or collaborative business, both internally and externally.

There are some differences between CRM and Social CRM. For example, CRM may often consist of one-way communication between a business and the customer. Social CRM may be an evolution of the CRM paradigm, and may represent the use of social media services, techniques and technology to enable organizations to engage with their customers. Social CRM may have example applications in, e.g., marketing, customer service and sales, including peer-to-peer customer support, idea management, market research, product launch, brand reputation management.

As an emerging discipline, interpretations of Social CRM may vary, but the most frequently used explanation includes how Social CRM is a philosophy and a business strategy, supported by a technology platform, business rules, workflow, processes and social characteristics, designed to engage the customer in a collaborative conversation in order to provide mutually beneficial value in a trusted and transparent business environment. It's the company's response to the customer's ownership of the conversation.

Users, such as sales individuals, may benefit from up to date real-time status on their (e.g., sales) opportunities to help immediately react to any changes and influence the “sale” in their favor. Additionally, for example in a team environment, dynamic teams based around the sales opportunity may help to be formed so that interested parties may easily share information about the opportunity, with the end goal to move the opportunity to the point where the sale may be made. The ability to close on the sale opportunity may become easier when conveying and updating information to the team, such as the membership of these teams, the stages of the sales opportunity, and the roles of the members.

The OM Process:

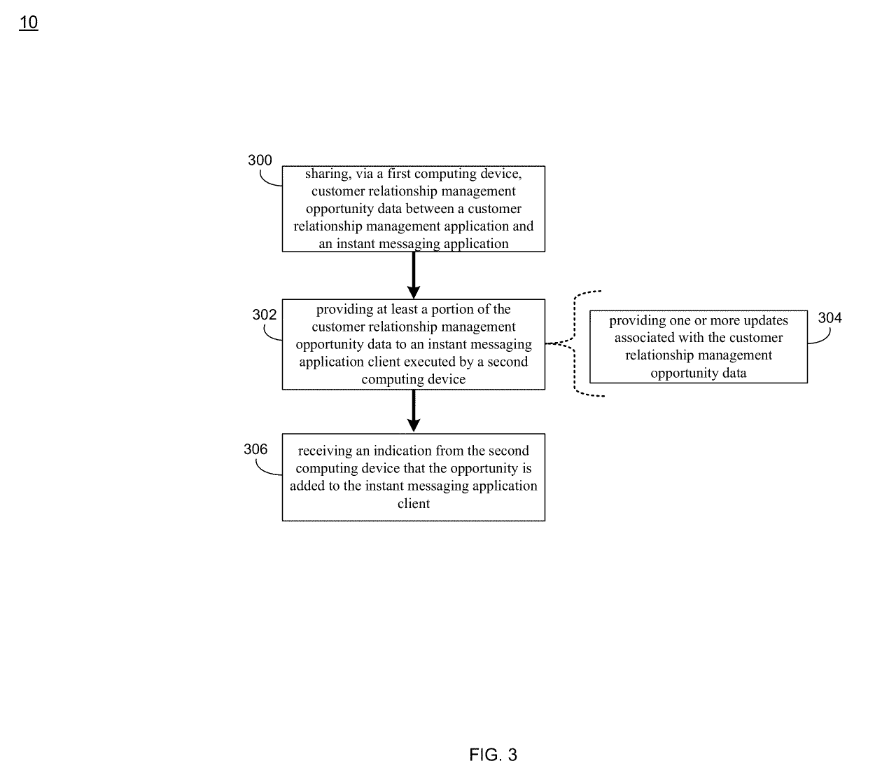

As discussed above and referring also to FIGS. 3-5, OM process 10 may share 300, via a first computing device (e.g., computer 12), customer relationship management opportunity data (e.g., data 17) between a customer relationship management application (e.g., CRM application 20) and an instant messaging application (e.g., collaboration application 21), wherein the customer relationship management opportunity data may be associated with an opportunity. At least a portion of the customer relationship management opportunity data may be provided 302 by OM process 10 to an instant messaging application client (e.g., client application 28) executed by a second computing device (e.g., client electronic device 44), the instant messaging application client associated with the instant messaging application, wherein at least the portion of the customer relationship management opportunity data may be provided 302 for user access at the second computing device via the instant messaging application client.

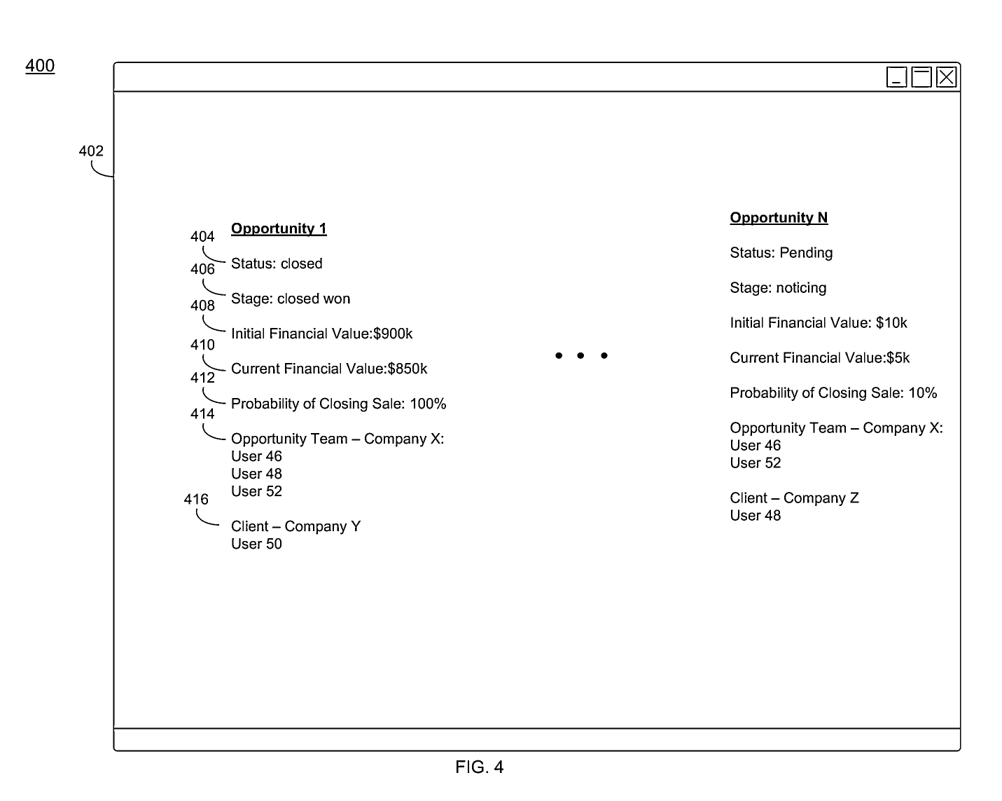

OM process 10 may share 300, via a first computing device (e.g., computer 12), customer relationship management opportunity data (e.g., data 17) between a customer relationship management application (e.g., CRM application 20) and an instant messaging application (e.g., collaboration application 21), wherein the customer relationship management opportunity data may be associated with an opportunity. For example, an opportunity (e.g., a sales opportunity) may include a company with something to sell (e.g., company X) and a company that may be a potential buyer (e.g., company Y). In some implementations, and referring at least to FIG. 4, an example user interface 400 associated with OM process 10, CRM application 20, collaboration application 21, client application 28, or combination thereof is shown. User interface 400 may include a window (e.g., window 402) which may display one or more sales opportunities, along with their associated artifacts or customer relationship management opportunity data (e.g., data 17). In some implementations, data 17 may be entered manually (e.g., via IM process 10). As will be discussed in greater detail below, at least some of data 17 may be dynamically updated.

In some implementations, at least the portion of the customer relationship management opportunity data may include at least one status associated with the opportunity. For example, data 17 may include the status of the opportunity (e.g., status 404), which may include, e.g., pending, closed, etc. In some implementations, at least one status associated with the opportunity may include at least one sale stage associated with the opportunity. For example, data 17 may include one or more icons that may represent the stage of the opportunity (e.g., stage 406), which may include where the opportunity currently is in the sales “pipeline”, e.g., noticing, noticed/identifying, identified/validating, qualified/gaining agreement, conditionally agreed/closing, won/implementing, won and complete, no bid, customer did not pursue, lost to competition, etc. Data 17 may include, for example, the initial financial value of the opportunity (e.g., initial financial value 408), which may include, e.g., the perceived initial value of the opportunity. Data 17 may include, for example, the current financial value of the opportunity (e.g., current financial value 410), which may include, e.g., the perceived initial value of the opportunity at a particular stage of the sales pipeline (e.g., beginning, middle, end, etc.). Data 17 may include, for example, the probability of closing the sale opportunity (e.g., probability of closing sale 412), which may include, e.g., the perceived likelihood that the sale will be made. In some implementations, at least the portion of the customer relationship management opportunity data may include one or more contacts associated with the opportunity. For example, data 17 may include one or more team member contacts associated with the opportunity (e.g., opportunity team 414), which may include, e.g., the team members for company X in charge of the sales opportunity. Examples of team members may include, e.g., technical staff, procurement staff, seller, manager, executive, etc. As another example, data 17 may include one or more client contacts associated with the opportunity (e.g., client 416), which may include, e.g., the contact for company Y in charge of purchasing the sales opportunity. In the example, having a client contact may provide the opportunity team 414 a central point to initiate communication with the contact and the ability to save and share the engagement with the opportunity team. Other examples of data 17 may be included without departing from the scope of the present disclosure.

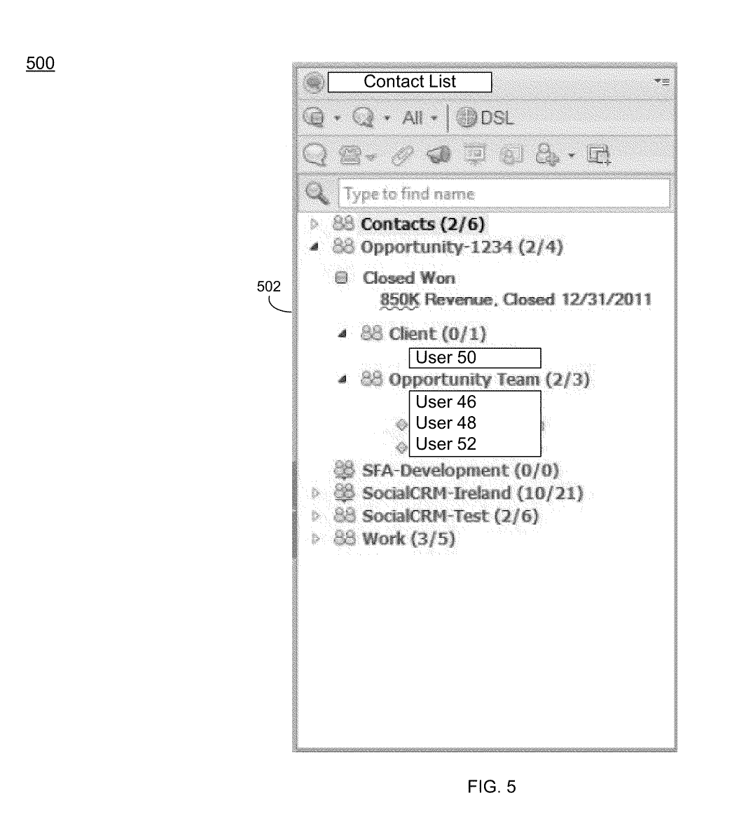

Data 17 may be shared 300 by OM process 10 with collaboration application 21, which may include, e.g., an instant messaging server application and/or a presence enabled application client. In some implementations, OM process 10 may provide 302 at least a portion of the customer relationship management opportunity data (e.g., data 17) to an instant messaging application client (e.g., client application 28) executed by a second computing device (e.g., client electronic device 44), the instant messaging application client associated with the instant messaging application, wherein at least the portion of the customer relationship management opportunity data may be provided 302 for user access at the second computing device via the instant messaging application client. For example, and referring at least to FIG. 5, an example user interface 500 associated with OM process 10, CRM application 20, collaboration application 21, client application 28, or combination thereof, may include a “buddy list” or “contact list” (e.g., contact list 502). In some implementations, contact list 502 may include similar functionality as that associated with known IM client applications (e.g., individual and/or group “chat” capabilities, visual status and/or presence notifications of each contact, etc.).

Assume for example purposes only that a user (e.g., user 52) has recorded (e.g., via OM process 10) customer relationship management opportunity data associated with opportunity 1 from FIG. 4. In the example, OM process 10 may provide 302 at least a portion of that data (e.g., data 17) to, e.g., collaboration application 21, which may provide 302 data 17 to client application 28. OM process 10 (e.g., via client application 28) may populate data 17 in contact list 502 such that user 52 (or any other user associated with the opportunity and contact list 502) may easily view and keep track of the progress of the opportunity.

In some implementations, an indication may be received 306 from the second computing device that the opportunity is added to the instant messaging application client, wherein at least the portion of the customer relationship management opportunity data may be provided 302 in response to receiving 306 the indication. For example, user 52 may via client application 28 user a cursor (not shown) to import or “drag” the opportunity from, e.g., window 402, to contact list 502. In the example, client application 28 may send a request for data 17, which may be received 306 by OM process 10 as an indication that the opportunity has been added to contact list 502 of client application 28. In response to receiving 306 the request, OM process 10 may provide 302 at least a portion of that data (e.g., data 17) to client application 28 to populate data 17 in contact list 502 as noted above. Other techniques of importing the opportunity from, e.g., window 402, to contact list 502 may be used. For example, user 52 may via client application 28 user a cursor (not shown) to select an “import opportunity” option from a menu associated with contact list 502. In some implementations, data 17 may be input manually by user 52 (e.g., via client application 28), which may be updated at CRM application 20 (e.g., via OM process 10).

In some implementations, when adding the opportunity to contact list 502, OM process 10 may create a group within contact list 502 that may include the above-noted contacts associated with the opportunity. In some implementations, the contacts of the group may be automatically and/or manually added to one or more of the user's buddy lists that are members of that group.

In some implementations, providing 302 at least the portion of the customer relationship management opportunity data may include OM process 10 providing 304 one or more updates associated with the customer relationship management opportunity data. In some implementations, the one or more updates may be provided 304 dynamically. For example, as the sales opportunity progresses through the sales pipeline, the customer relationship management opportunity data may change. For instance, at the beginning stage of the sales opportunity, the initial financial value of the sales opportunity may be $900 k as indicated at initial financial value 408. At the earlier stages, the probability of closing the sale may be, e.g., 10%. As the sales opportunity progresses towards the final stages of the sales pipeline, it is possible that the probability of closing the sale may increase, but the current financial value of the sales opportunity may be decreased to $850 k as indicated at current financial value 410. This may be due to, e.g., negotiations between team members of company X and contacts of company Y. In response to one or more changes in the sales opportunity (data), such changes or updates may be provided 304 by user 52 via OM process 10 to client application 28 in an example form of presence publishes to populate the updates to data 17 in contact list 502 as noted above. Use of an access control list, for example, may limit who is able to input such updates, as well as add new opportunities. In some implementations, some updates to data 17 may be provided automatically by OM process 10 (e.g., after pre-determined timing intervals, scheduled times, etc.) and/or in conjunction with other updates. For example, if user 48 is no longer necessary at a particular stage of the sales pipeline, OM process 10 may automatically remove user 48 from the portion of the contact list associated with the opportunity. Conversely, if user 48 is now necessary at a particular stage of the sales pipeline, OM process 10 may automatically add user 48 to the portion of the contact list associated with the opportunity. In some implementations, some updates to data 17 may be provided by OM process 10 manually via a “refresh” command initiated by user 52 via OM process 10.

In some implementations, user 52 via client application 28 may provide notes associated with the opportunity. For example, user 52 may send an instant message to the opportunity (and/or individual members associated with the opportunity). In some implementations, sending an instant message (e.g., a private message) to the opportunity may enable the note to be viewed by the individual members associated with the opportunity (e.g., via an event log, forum or social blog associated with the opportunity). In some implementations, the notes may be provided by user 52 “posting” the note via client application 28 on a comment “wall” associated with the opportunity. In some implementations, posting the note on the comment wall associated with the opportunity may enable the note to be viewed by the individual members associated with the opportunity (e.g., via an event log, forum or social blog associated with the opportunity).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A computer-implemented method comprising:
sharing, via a first computing device, customer relationship management opportunity data between a customer relationship management application and an instant messaging application, wherein the customer relationship management opportunity data is associated with an opportunity; and
providing at least a portion of the customer relationship management opportunity data to an instant messaging application client executed by a second computing device, the instant messaging application client associated with the instant messaging application, wherein at least the portion of the customer relationship management opportunity data is provided for user access at the second computing device via the instant messaging application client.

2. The computer-implemented method of claim 1 wherein at least the portion of the customer relationship management opportunity data includes one or more contacts associated with the opportunity.

3. The computer-implemented method of claim 1 wherein at least the portion of the customer relationship management opportunity data includes at least one status associated with the opportunity.

4. The computer-implemented method of claim 3 wherein the at least one status associated with the opportunity includes at least one sale stage associated with the opportunity.

5. The computer-implemented method of claim 1 wherein providing at least the portion of the customer relationship management opportunity data includes providing one or more updates associated with the customer relationship management opportunity data.

6. The computer-implemented method of claim 5 wherein the one or more updates are provided dynamically.

7. The computer-implemented method of claim 1 further comprising receiving an indication from the second computing device that the opportunity is added to the instant messaging application client, wherein at least the portion of the customer relationship management opportunity data is provided in response to receiving the indication.

8. A computing system including a processor and a memory configured to perform operations comprising:
sharing, via a first computing device, customer relationship management opportunity data between a customer relationship management application and an instant messaging application, wherein the customer relationship management opportunity data is associated with an opportunity; and
providing at least a portion of the customer relationship management opportunity data to an instant messaging application client executed by a second computing device, the instant messaging application client associated with the instant messaging application, wherein at least the portion of the customer relationship management opportunity data is provided for user access at the second computing device via the instant messaging application client.

9. The computing system of claim 8 wherein at least the portion of the customer relationship management opportunity data includes one or more contacts associated with the opportunity.

10. The computing system of claim 8 wherein at least the portion of the customer relationship management opportunity data includes at least one status associated with the opportunity.

11. The computing system of claim 10 wherein the at least one status associated with the opportunity includes at least one sale stage associated with the opportunity.

12. The computing system of claim 8 wherein providing at least the portion of the customer relationship management opportunity data includes providing one or more updates associated with the customer relationship management opportunity data.

13. The computing system of claim 12 wherein the one or more updates are provided dynamically.

14. A computer program product residing on a computer readable storage medium having a plurality of instructions stored thereon which, when executed by a processor, cause the processor to perform operations comprising:
sharing, via a first computing device, customer relationship management opportunity data between a customer relationship management application and an instant messaging application, wherein the customer relationship management opportunity data is associated with an opportunity; and
providing at least a portion of the customer relationship management opportunity data to an instant messaging application client executed by a second computing device, the instant messaging application client associated with the instant messaging application, wherein at least the portion of the customer relationship management opportunity data is provided for user access at the second computing device via the instant messaging application client.

15. The computer program product of claim 14 wherein at least the portion of the customer relationship management opportunity data includes one or more contacts associated with the opportunity.

16. The computer program product of claim 14 wherein at least the portion of the customer relationship management opportunity data includes at least one status associated with the opportunity.

17. The computer program product of claim 16 wherein the at least one status associated with the opportunity includes at least one sale stage associated with the opportunity.

18. The computer program product of claim 14 wherein providing at least the portion of the customer relationship management opportunity data includes providing one or more updates associated with the customer relationship management opportunity data.

19. The computer program product of claim 18 wherein the one or more updates are provided dynamically.

20. The computer program product of claim 14 further comprising receiving an indication from the second computing device that the opportunity is added to the instant messaging application client, wherein at least the portion of the customer relationship management opportunity data is provided in response to receiving the indication.
